(19) United States
(12) Patent Application Publication
(10) Pub. No.: US 2002/0191340 A1
(43) Pub. Date: Dec. 19, 2002

(54) Disc head slider having an air bearing surface for improved damping

(76) Inventors: Mark A. Chapin, Louisville, CO (US); Michael D. Mundt, Longmont, CO (US); Gary E. Bement, Frederick, CO (US); Scott E. Ryun, Prior Lake, MN (US); Ram M. Rao, Roseville, MN (US); Anthony P. Sannino, Longmont, CO (US); Deborah S. Schnur, Minneapolis, MN (US)

Correspondence Address: Todd R. Fronek, WESTMAN CHAMPLIN & KELLY, International Centre - Suite 1600, 900 South Second Avenue, Minneapolis, MN, 55402-3319, US

(21) Appl. No.: 10/116,740

(22) Filed: Apr. 4, 2002

Related U.S. Application Data
(60) Provisional application No. 60/293,279, filed on May 23, 2001.
(60) Provisional application No. 60/281,476, filed on Apr. 4, 2001.

(51) Int. Cl. G11B 5/60

(52) U.S. Cl. 360/235.8; 360/236.3

(57) ABSTRACT

The present invention includes a head slider for a disk drive. The slider includes a slider body having leading and trailing slider edges and first and second side edges. The body further includes an air bearing surface configured to face a disk surface. A raised portion is portioned on the air bearing surface. A plurality of isolated cup-shaped features having openings facing the leading slider edge is positioned on the raised portion. Furthermore, the plurality of cup-shaped features extends substantially from the leader slider edge to the trailing slider edge.

### CROSS-REFERENCE TO RELATED APPLICATIONS

This application claims priority from U.S. Provisional Application No. 60/293,279 filed on May 23, 2001 for inventors Mark A. Chapin, Michael D. Mundt, Anthony P. Sannino, and Gary E. Bement and entitled RANDOMIZED TRENCH AAB FOR PAMR, and U.S. Provisional Application No. 60/281,476 filed on Apr. 4, 2001 for inventors Scott E. Ryun, Ram M. Rao, Anthony P. Sannino and Deborah S. Schnur and entitled RECESSED AIR BEARING FEATURES FOR INCREASED FLUID DYNAMIC DAMPING, the contents of which are both hereby incorporated by reference.

### FIELD OF THE INVENTION

The present invention relates generally to disc drive data storage systems, and more particularly but not by limitation to a disc drive data storage system having a slider with an air bearing design for reducing fly height modulation.

### BACKGROUND OF THE INVENTION

Disc drives of the “Winchester” and optical types are well known in the industry. Such drives use rigid discs, which are coated with a magnetizable medium for storage of digital information in a plurality of circular, concentric data tracks. Increased track density on the discs provides added storage space. The discs are mounted on a spindle motor, which causes the discs to spin and the surfaces of the discs to pass under respective hydrodynamic (e.g. air) bearing disc head sliders. The sliders carry transducers, which write information to and read information from the disc surfaces.

An actuator mechanism moves the sliders from track-to-track across the surfaces of the discs under control of electronic circuitry. Positioning information (known in the art as servo information) is provided on the disc surface to aid in positioning of the slider on a particular track. The servo information is typically in the form of magnetic patterns, or “bursts”. Ever increasing track densities has required the need for pattern assisted magnetic recording (PAMR). Typically, a PAMR servo bust replaces traditional magnetic servo bursts with physical pits. The slider senses the physical pit and provide a signal accordingly. The PAMR servo bursts range from 10 to 25 nm in depth and 20 to 80 μm in length. There can be as many as 1000 PAMR bursts per disc revolution. The actuator mechanism includes a track accessing arm and a suspension for each head gimbal assembly. The suspension includes a load beam and a gimbal. The load beam provides a load force that forces the slider toward the disc surface. The gimbal is positioned between the slider and the load beam, or is integrated in the load beam, to provide a resilient connection that allows the slider to pitch and roll while following the topography of the disc.

The slider includes a bearing surface, which faces the disc surface. As the disc rotates, the disc drags air under the slider and along the bearing surface in a direction approximately parallel to the tangential velocity of the disc. As the air passes beneath the bearing surface, air compression along the air flow path causes the air pressure between the disc and the bearing surface to increase, which creates a hydrodynamic lifting force that counteracts the load force and causes the slider to lift and fly above or in close proximity to the disc surface. As the head flies over the PAMR servo bursts or perturbations, the fly height of the head modulates in a complicated manner. This modulation must be minimized to ensure the performance of the read/write transducer. Typically, the total modulation of the head must be less than ±10% of the nominal fly height. Embodiments of the present invention provide solutions to these and other problems, and offer other advantages over the prior art.

### SUMMARY OF THE INVENTION

The present invention relates to head sliders with advanced air bearing designs that address the above-mentioned problem. In one embodiment, a slider is provided in a disc drive storage system. The slider includes a slider body and first and second side edges. The body further includes an air bearing surface configured to face a disc surface. A raised portion is portioned on the air bearing surface. A plurality of isolated cup-shaped features having openings facing the leading slider edge are positioned on the raised portion. Furthermore, the plurality of cup-shaped features extends substantially from the leading slider edge to the trailing slider edge.

Another aspect of the present invention is a method of flying a slider over a disc having a patterned disc surface. The method includes providing a slider with an air bearing surface configured to face the disc surface. A raised portion is positioned on the air bearing surface and a plurality of isolated cup-shaped features are provided on the raised portion. The plurality of cup-shaped features extends substantially from the leading slider edge to the trailing slider edge and include openings facing the leading slider edge.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 is a schematic view of a slider flying over a disc surface.

FIGS. 3-1 is a bottom plan view of a slider air bearing.

FIGS. 3-2 is a pressure profile of the slider illustrated in FIGS. 3-1.

FIG. 4 is a schematic view of a portion of the slider in FIGS. 3-1.

FIGS. 5-1 is a bottom plan view of a slider air bearing.

FIGS. 5-2 is a pressure profile of the slider illustrated in FIGS. 5-1.

FIG. 6 is a graph of numerical simulations that show fly-height modulation of the sliders of FIGS. 3-1 and 5-1.

FIGS. 7-1 is a perspective view of a slider air bearing.

FIGS. 7-2 is an illustration of a pressure contour of the slider illustrated in FIGS. 7-1.

FIGS. 8-1 is a perspective view of a slider air bearing.

FIGS. 8-2 is an illustration of a pressure contour of the slider illustrated in FIGS. 8-1.

FIGS. 9-1 is a perspective view of a slider air bearing.

FIGS. 9-2 is an illustration of a pressure contour of the slider illustrated in FIGS. 9-1.

### DETAILED DESCRIPTION OF ILLUSTRATIVE EMBODIMENTS

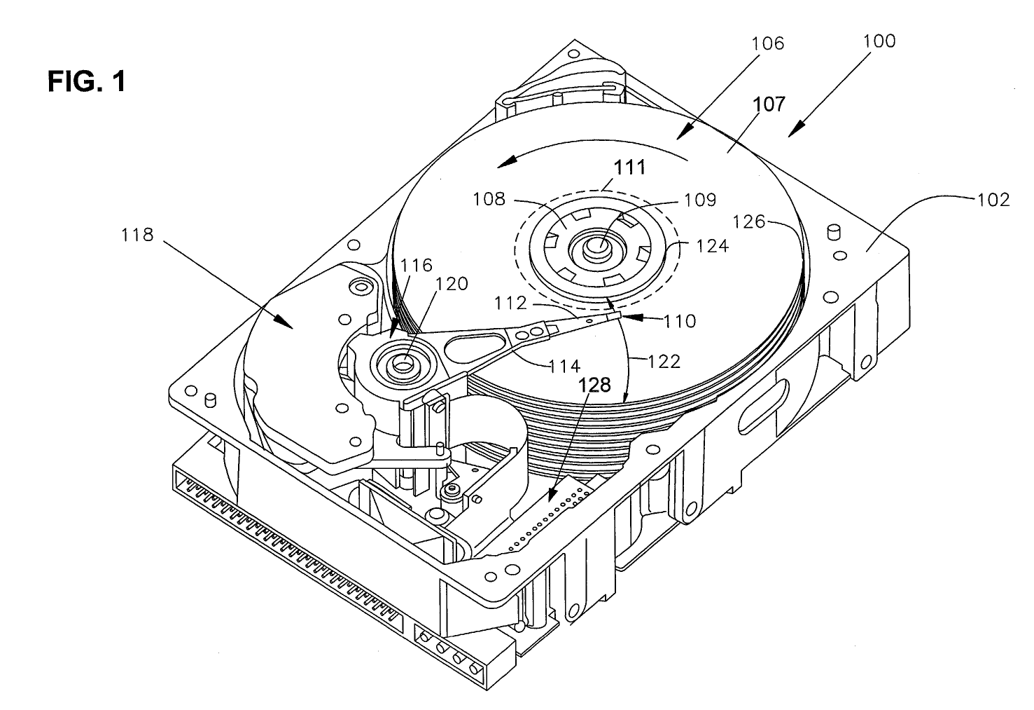

FIG. 1 is an isometric view of a disc drive 100 in which embodiments of the present invention are useful. Disc drive 100 can be any type of storage device such as an optical or magnetic type. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs 107, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track 111, for example, along an arcuate path 122 between a disc inner diameter 124 and a disc outer diameter 126. Voice coil motor 118 operates under control of internal circuitry 128.

In accordance with an embodiment of the present invention, sliders 110 and others herein described include specialized features formed in their surfaces that face discs 107. Illustratively, some of these specialized features enable reductions in fly height modulation of slider 110 with respect to disc 107. Also, some of these specialized features illustratively enable beneficial slider flight performance characteristics, such as a desirable pitch and/or roll stiffness and increased damping. The features also provide pressure dispersal and dissipation of shear stress as a slider passes over perturbations on the disc. Generally, the features can be isolated and formed of various shapes and sizes. For example, the features may be recesses, channels, pads, protrusions, bumps, polygons, rectangles, circles, cut-outs, triangles or other elements. Precisely which flight performance characteristics are beneficial or desirable is dependent at least upon the nature and environment of a given slider application. For purposes of this description, when reference is made to a cup-shape, it should be assumed that the shape generally has at least a portion defining a depression and includes a variety of shapes including squares, rectangles, triangles, polygons, concave surfaces, angled portions and the like.

As will be described below, at least one and potentially several of the disc-facing surface features on the sliders (i.e., slider 110) include a bearing surface. When a slider is positioned relative a disc (i.e., disc 107 in FIG. 1), the bearing surface(s) will generally be positioned closer to the disc than other surfaces. Illustratively, the bearing surface(s) are generally in a plane that, for the purpose of the present description, will be referred to as the bearing surface plane. In accordance with one embodiment, a slider includes multiple bearing surfaces that are generally coplanar within the bearing surface plane and are therefore positioned approximately the same distance from the disc (i.e., disc 107).

Generally speaking, when a disc head slider operates within a disc drive, the slider is typically configured to pitch and roll in response to various topographical features associated with a disc surface. Also, many sliders are configured to demonstrate an operational pitch wherein the trailing end is in closer proximity to the disc surface than the leading end. It should be pointed out, that in the context of the present description, when references are made to the position of slider surfaces relative a disc (e.g., one surface extends further towards the disc surface than another), it should be assumed that the slider is positioned in a plane that is generally parallel with the disc surface (the slider generally positioned flatly without any pitch or roll displacement).

It should be pointed out that it is common for disc head sliders to include a slight curvature in their length and/or width directions. Such curvatures are commonly referred to as slider crown curvature and slider cross curvature. Accordingly, it is to be understood that the surfaces and surface planes described herein, including the bearing surface plane, may reflect slider crown and cross curvature, rather than being disposed in a perfectly flat plane.

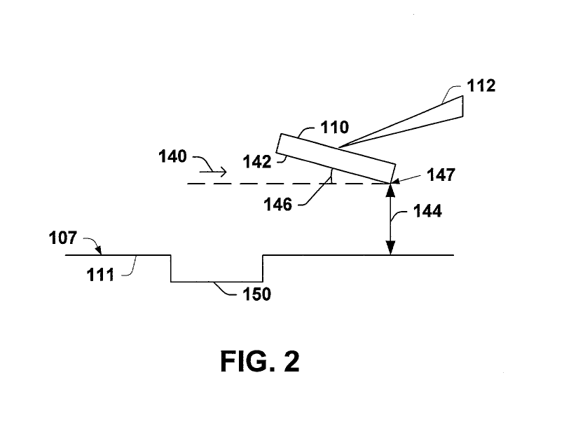

FIG. 2 is a schematic diagram of suspension 112 carrying slider 110 along data track 111. Disc 107 includes a patterned disc surface. As disc 107 rotates, an airflow 140 is created that acts against a bearing surface 142 of slider 110. Airflow 140 creates a hydrodynamic lifting force and causes slider 110 to fly above a surface of disc 107 at a fly height 144 and a pitch angle 146. Fly height is measured from point 147 (which is the point on slider 110 closest to the disc surface) to the disc surface. Pitch angle is an angle between a line extending from a point 147 parallel to the surface of disc 107 and a line parallel to bearing surface 142. As slider 110 passes over PAMR servo bursts 150, airflow 140 is disrupted, which causes slider 110, and thus fly height 144, to modulate. In particular, when slider 110 flies over PAMR burst 150, pressure between slider 110 and the disc surface decreases, causing slider 110 to “fall” towards the disc surface. When slider 110 reaches the edge of burst 150, pressure increases, causing a force on bearing surface 142. This change is pressure causes fly height modulation. Although illustrated as a PAMR servo burst, burst 150 can be any type of pattern on the disc surface such as a thermal asperity or other physical projection or depression that causes modulation of slider 110.

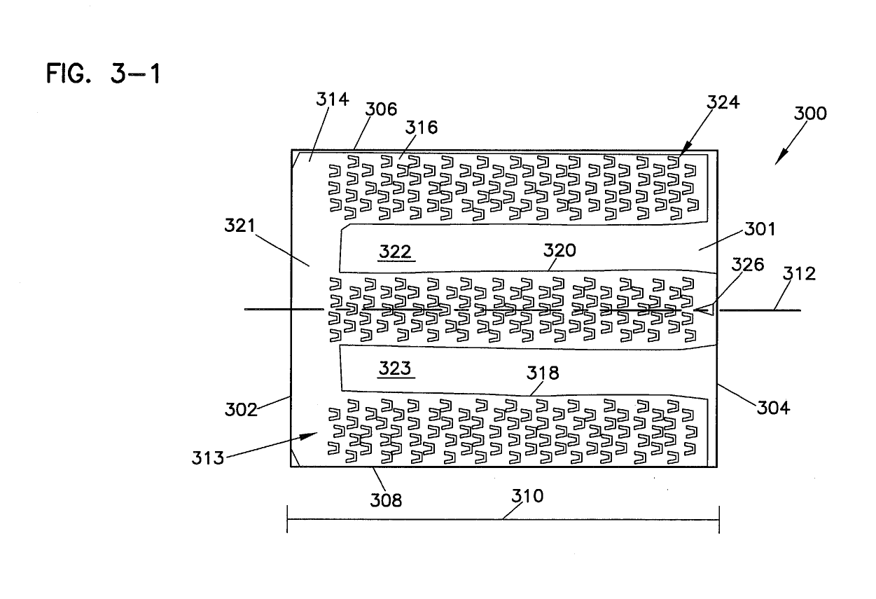

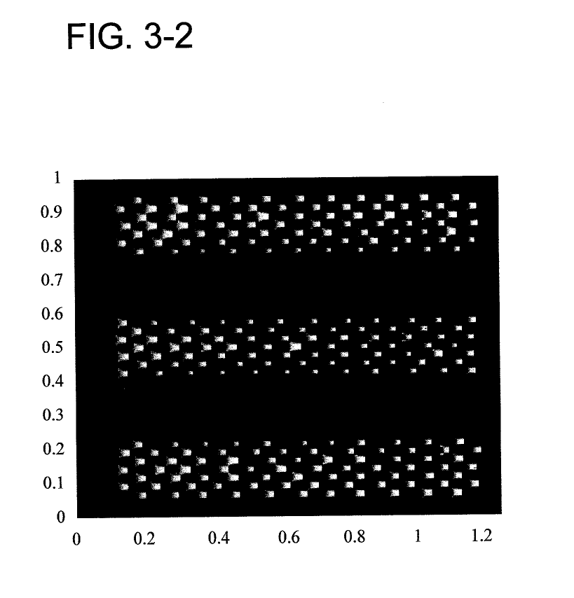

FIGS. 3-1 illustrates an exemplary slider 300 for use in disc drive 100 as slider 110 in accordance with an embodiment of the present invention. Slider 300 includes slider body 301 having leading slider edge 302 and trailing slider edge 304. In addition, slider body 301 includes first and second side edges 306 and 308, respectively. Slider body 301 further includes length 310 along center line 312 extending from leading slider edge 302 to trailing slider edge 304. Slider body 301 also has an air bearing surface 313 configured to face a disc surface. Cavity dam 314 is disposed along leading slider edge 302 and extends substantially between side edges 306 and 308.

Raised rails 316 and 318 extend rearward from cavity dam 314 and are positioned along side edges 306 and 308, respectively. A raised center rail 320 is positioned along slider center line 312. Collectively, cavity dam 314, and rails 316, 318 and 320 form a raised portion 321 positioned on the air bearing surface 313. Raised portion 321 is raised above slider body 301 in the range of about 0.6 to 5 microns. Although the raised portion is illustrated as a cavity dam and rails, those skilled in the art will recognize that any raised portion can be used in accordance with the present invention. Such raised portions include bulges, bumps, projections or other elements raised above the slider body 301. Sub-ambient pressure cavities 322 and 323 extend rearward of cavity dam 314 and on either side of center rail 320.

A plurality of cup-shaped features 324 (herein protrusions) extends substantially from leading slider edge 302 to trailing slider edge 304. The plurality of cup-shaped protrusions 324 are isolated and extend above raised portion 321 in the range of about 0.1 to 0.5 microns. Each of the plurality of cup-shaped protrusions have an opening facing leading slider edge 302 and are positioned on raised portion 321. As illustrated, the plurality of cup-shaped protrusions are randomized in a direction from leading slider edge 302 to trailing slider edge 304 and can be positioned on rails 316, 318 and 320. Slider 300 further carries transducer 326, located near trailing edge 304, for read/write operation.

FIGS. 3-2 illustrates a pressure profile for slider 300 when used in disc drive 100. As shown, pressure is uniformly distributed from leading slider edge 302 to trailing sliding edge 304. In addition, pressure is isolated about each of the plurality of cup-shaped protrusions 324. These isolated pressure gradients further dampen modulation of slider 300. Since pressure is uniformly distributed from leading slider edge 302 to trailing slider edge 304, slider 300 flies at a low pitch angle. In one embodiment, the pitch angle is less than 50 microrads. The low pitch angle contributes to reduced fly height modulation when flying over PAMR servo bursts.

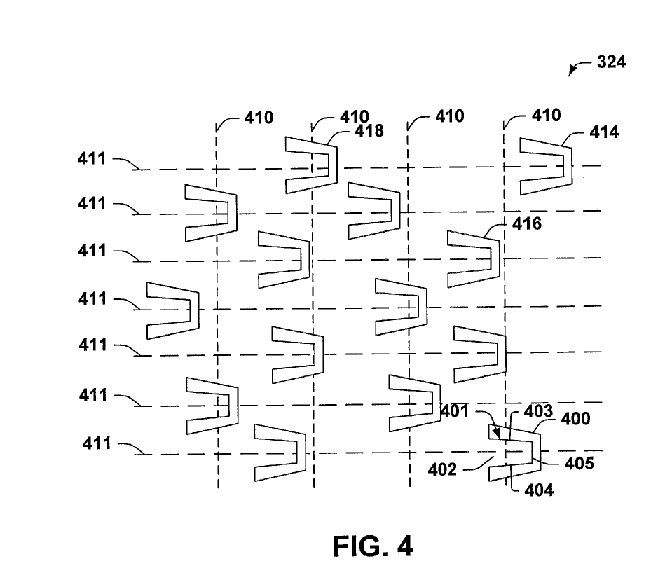

FIG. 4 schematically illustrates an arrangement of the plurality of cup-shaped protrusions 324 in accordance with an embodiment of the present invention. By way of example, cup-shaped protrusion 400 is substantially symmetrical and has a recessed convergent channel 401. Recessed convergent channel 401 can be of any depth or shape, as desired. As illustrated, channel 401 is adapted to converge pressure to an end for isolation. In one embodiment, channel 401 has a depth in a range from about 0.1 to 0.5 microns. Leading channel end 402 is open to fluid flow from leading slider edge 302. Fluid flow is forced from leading channel end 402 between non-divergent walls 403 and 404 to trailing channel end 405. Trailing channel end 405 blocks fluid flow. This structure forces the fluid flow to exit channel 401 over trailing channel end 405. Further, this creates localized isolated positive pressure on cup-shaped protrusion 400 and prevents airflow from bleeding into sub-ambient pressure cavities 322 and 323.

A variety of different cup-shaped protrusions other than cup-shaped protrusion 400 can be used in order to practice the present invention. For example, cup-shaped protrusions 400 can be non-symmetrical and include curved portions. Alternatively, each of the plurality of cup-shaped protrusions 324 can be different shapes in accordance with the present invention. The plurality of cup-shaped protrusions 324 can be applied to slider 300 by well known processes. These include lithography, etching, ion milling or any combination thereof.

As illustrated, the plurality of cup-shaped protrusions 324 are arranged in a plurality of columns 410 and a plurality of rows 411. For each of the plurality of columns 410, the plurality of cup-shaped protrusions 324 positioned along that column is offset a distance about the column with respect to at least one other cup-shaped protrusion in the column. By way of example, cup-shaped protrusion 414 is offset a distance about its respective column 410 with respect to cup-shaped protrusion 416, which is positioned in the same column. For each of the plurality of rows 411, the cup-shaped protrusions are substantially aligned along the row. By way of example, cup-shaped protrusions 414 and 418, which are located in the same row, are substantially aligned along the row. This arrangement allows the plurality of cup-shaped protrusions 324 to uniformly distribute pressure along slider 300 from leading slider edge 302 to trailing slider edge 304. Also, for each row, cup-shaped protrusions 414 and 418 are provided in every other column to further uniformly distribute pressure across air bearing surface 313. This uniform pressure distribution reduces fly height modulation of slider 300. Arrangements for the plurality of cup-shaped protrusions 324, such as randomized patterns, straight-line angular patterns, uniform patterns and others may be used.

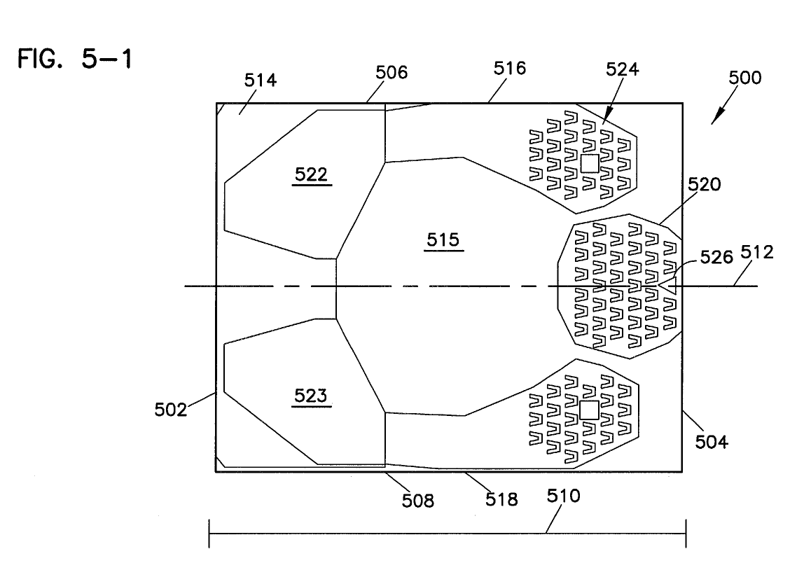

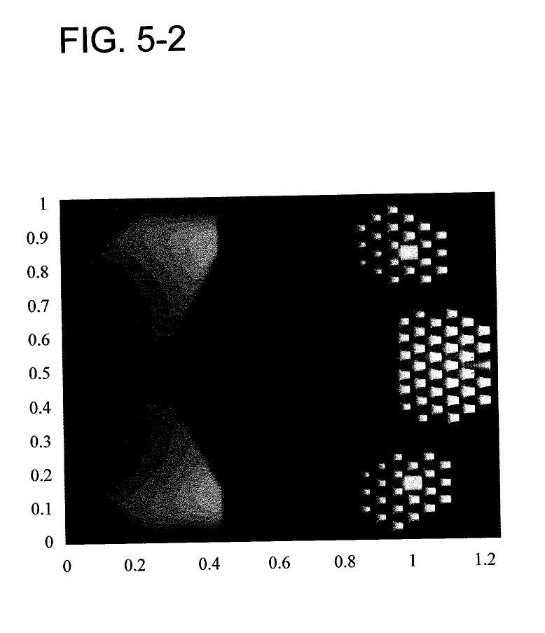

In order to determine the effectiveness of slider 300 in reducing fly height modulation, numerical simulations were performed to determine fly height modulation of slider 300 and a comparative slider when flying over a disc surface having PAMR servo bursts. FIGS. 5-1 illustrates slider 500 used in the numerical simulations. Slider 500 includes leading slider edge 502 and trailing slider edge 504. In addition, slider 500 includes first and second side edges 506 and 508, respectively. Slider 500 further includes length 510 along center line 512 extending from leading slider edge 502 to trailing slider edge 504. Cavity dam 514 forms sub-ambient pressure cavity 515 and is disposed along leading slider edge 502 and extends substantially between side edges 506 and 508. Raised rails 516 and 518 extended rearward from cavity dam 514 and are positioned along slider edges 506 and 508, respectively. A raised center pad 520 is positioned along trailing slider edge 504. Step surfaces 522 and 523 are positioned on cavity dam 514. A plurality of cup-shaped protrusions 524 are disposed near the trailing slider edge 504 and positioned on rails 516 and 518, as well as center pad 520. The plurality of cup-shaped protrusions 524 are substantially aligned in columns parallel to trailing slider edge 504. Slider 500 carries transducer 526, located near trailing edge 504, for read/write operations.

FIGS. 5-2 illustrates a pressure distribution for slider 500 when used in disc drive 100. As shown, pressure is concentrated near step surfaces 522 and 523 and the plurality of cup-shaped protrusions 524. Pressure near step surfaces 522 and 523 contribute to a larger pitch angle for slider 500 than slider 300. Pressure concentrated near the plurality of cup-shaped protrusions 524 yields increased fly height modulation compared to that of slider 300 over PAMR servo bursts.

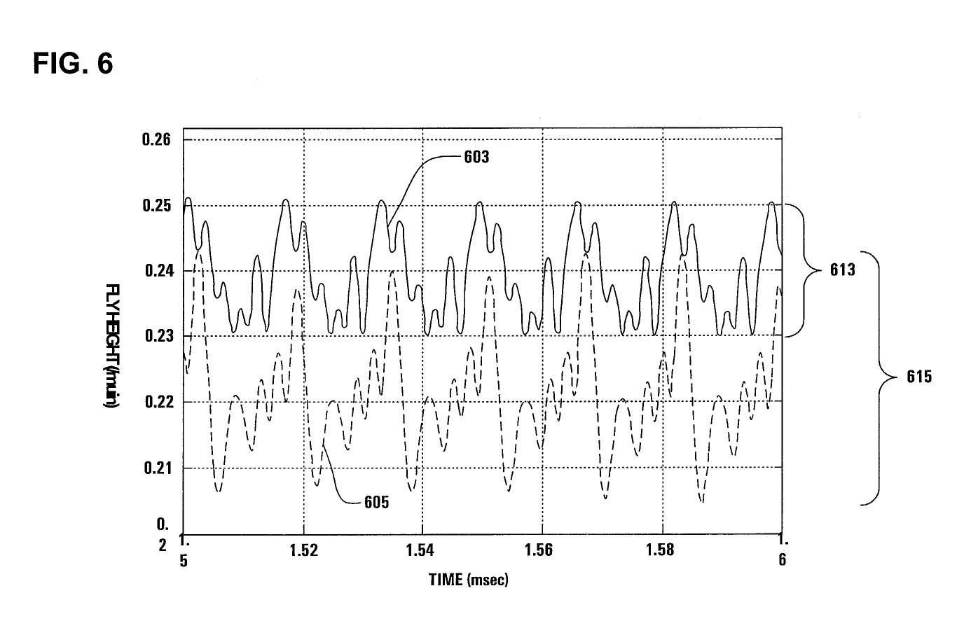

FIG. 6 is a graph with the vertical axis representing fly height of a slider and the horizontal axis representing time. Segment 603 represents the modulation of slider 300 while segment 605 represents modulation of slider 500. Range 613 of segment 603 is smaller than range 615 of segment 605. The numerical simulation calculated that slider 300 had a plus or minus 4.2 percent fly height modulation (corresponding to range 613) while slider 500 had a plus or minus 9 percent modulation (corresponding to range 615). The fly heights of both slider 300 and slider 500 were approximately 0.25 micro inches. Slider 300 flew at a pitch of approximately 25 microrads while slider 500 flew at a pitch angle of approximately 185 microrads. Thus, the air bearing of slider 300 reduced fly height modulation by over 50% when compared with slider 500.

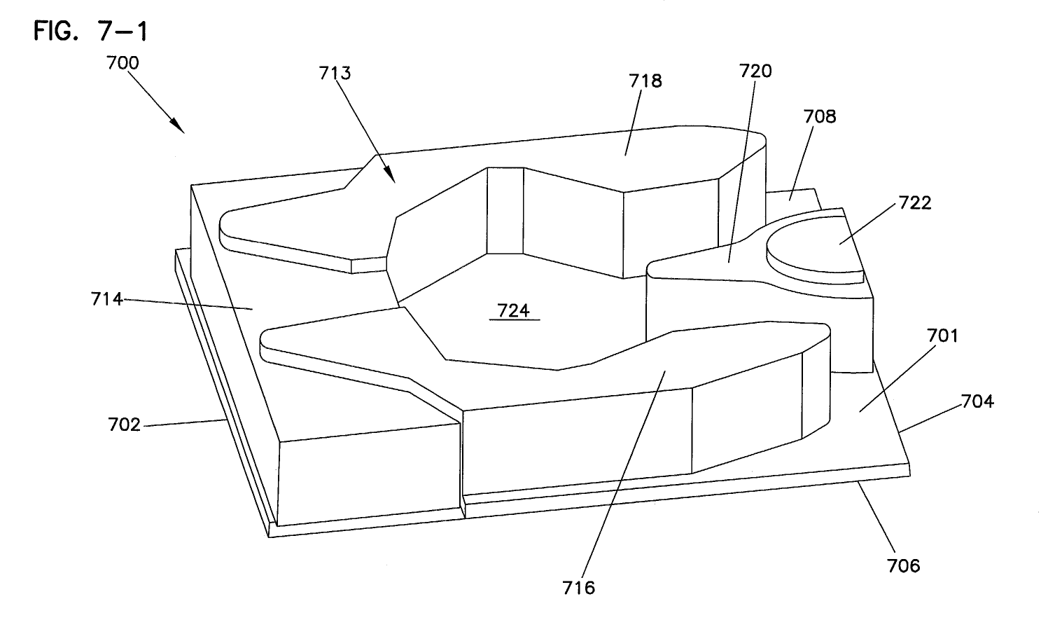

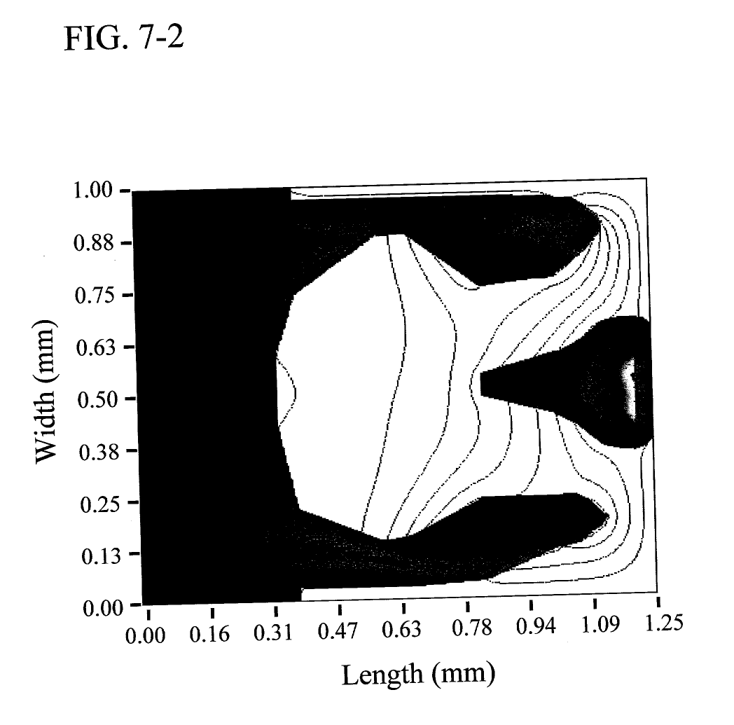

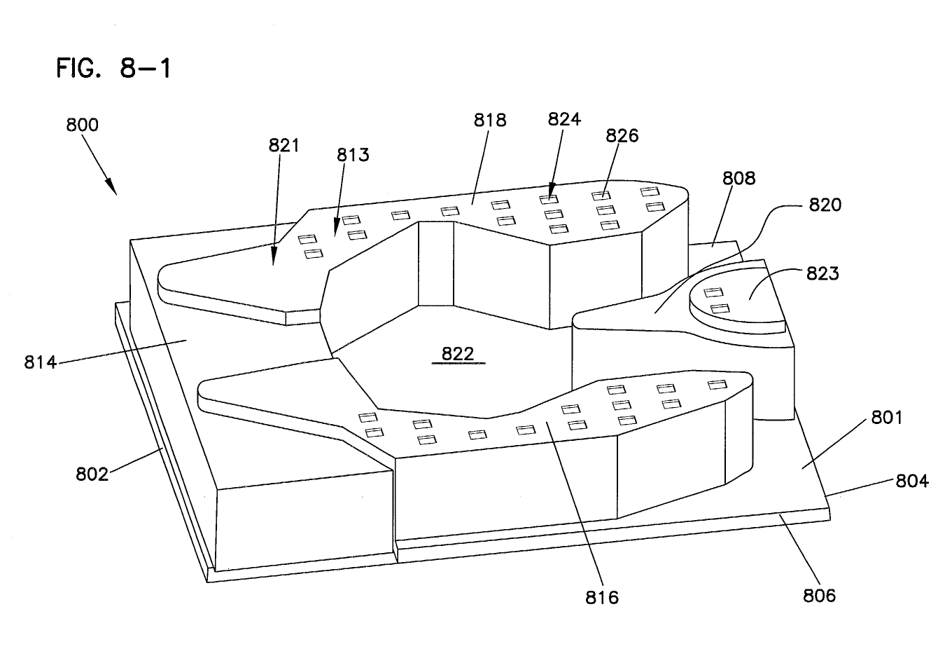

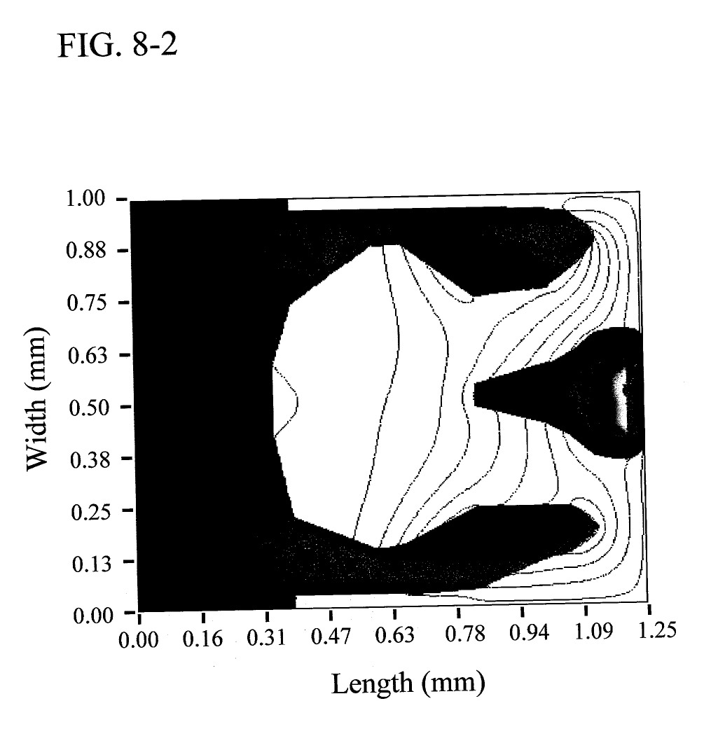

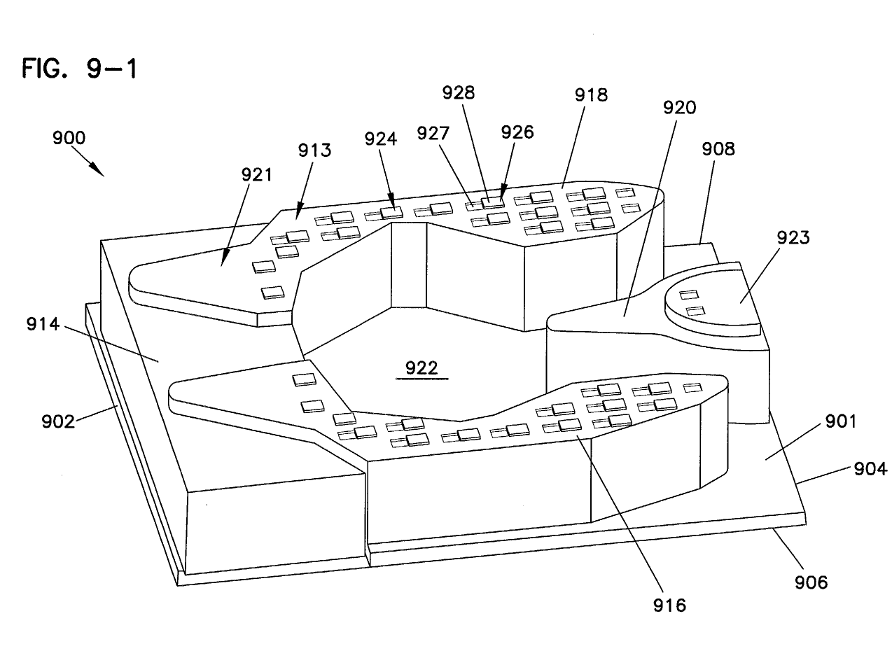

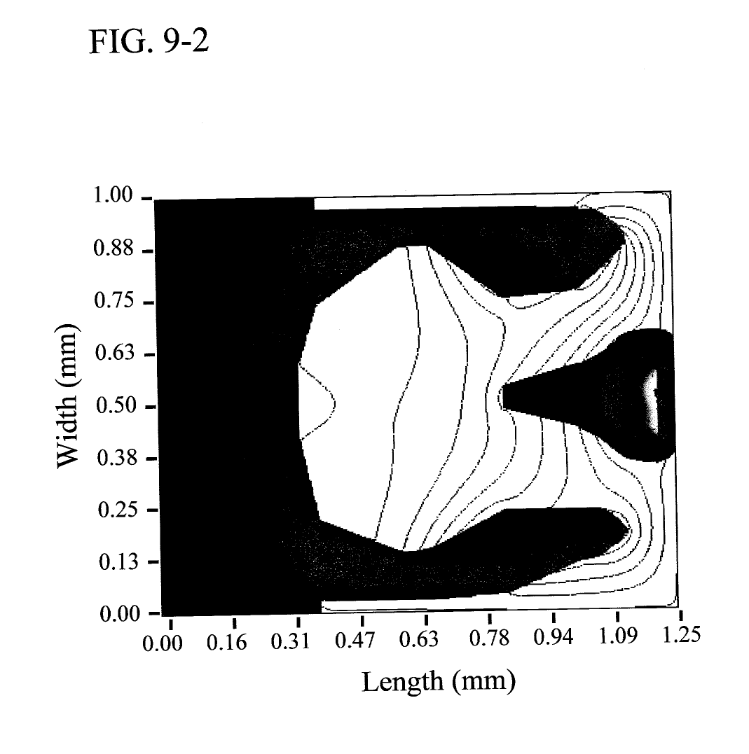

As appreciated by those skilled in the art, other slider designs can be achieved in accordance with the present invention. In order to test these designs, further numerical simulations demonstrate increased damping characteristics of alternative slider designs. A numerical simulation involving a control air bearing (illustrated in FIGS. 7-1), an air bearing with recessed features (illustrated in FIG. 8-1) and an air bearing having both recessed and raised features (illustrated in FIG. 9-1) is described below.

FIGS. 7-1 illustrates slider 700 with a control air bearing. Slider 700 includes slider body 701 having leading slider edge 702 and trailing slider edge 704. In addition, slider body 701 includes first and second side edges 706 and 708, respectively. Slider body 701 also has an air bearing surface 713 configured to face a disc surface. Cavity dam 714 is disposed along leading slider edge 702 and extends substantially between side edges 706 and 708.

Raised rails 716 and 718 extend rearward from cavity darn 714 and are positioned along side edges 706 and 708, respectively. A raised center pad 720 is positioned near trailing edge 704. A raised surface 722 is positioned on center pad 720. A sub-ambient pressure cavity 724 extends rearward of cavity dam 714.

FIG. 7-2 illustrates a pressure contour for slider 700. As illustrated, pressure is fairly concentrated at the side rails 716, 718 and center pad 720. Accordingly, when slider 700 passes over a perturbation, more force is placed on bearing surface 713, which results in fly height modulation.

FIGS. 8-1 illustrates an exemplary slider 800 for use in disc drive 100 as slider 110 in accordance with an embodiment of the present invention. Slider 800 includes slider body 801 having leading slider edge 802 and trailing slider edge 804. In addition, slider body 801 includes first and second side edges 806 and 808, respectively. Slider body 801 also has an air bearing surface 813 configured to face a disc surface. Cavity darn 814 is disposed along leading slider edge 802 and extends substantially between side edges 806 and 808.

Raised rails 816 and 818 extend rearward from cavity dam 814 and are positioned along side edges 806 and 808, respectively. A raised center pad 820 is positioned near trailing slider edge 804 and includes a raised step surface 823. Collectively, cavity dam 814, and rails 816, 818 and pad 820 (along with step surface 823) form a raised portion 821 positioned on the air bearing surface 813. Raised portion 821 is raised above slider body 801 in the range of about 0.6 to 5 microns. Although the raised portion is illustrated as a cavity dam, a pad and rails, those skilled in the art will recognize that any raised portion can be used in accordance with the present invention. Such raised portions include bulges, bumps, projections or other elements raised above the slider body 801. Sub-ambient pressure cavity 822 extends rearward of cavity dam 814 and between side rails 816 and 818.

A plurality of cup-shaped features 824 (in this case recesses) extends substantially from leading slider edge 802 to trailing slider edge 804. The plurality of cup-shaped features 824 extend below raised portion 821 in the range of about 0.05 to 0.5 microns. Each of the plurality of cup-shaped features 824 have an opening facing leading slider edge 802 and are positioned on raised portion 821. In the embodiment illustrated, the plurality of features 824 are rectangular in shape, but other shapes may be used. As illustrated, the plurality of cup-shaped features 824 are isolated and arranged in rows from leading slider edge 802 to trailing slider edge 804 and can be positioned on rails 816, 818 and pad 820.

By way of example, cup-shaped feature 826 is substantially symmetrical and is a recessed convergent channel similar to channel 401 described in relation to FIG. 4. The recessed convergent channel can be of any depth or shape, as desired. As illustrated, feature 826 is adapted to converge pressure to an end for isolation. A leading channel end of feature 826 is open to fluid flow from leading slider edge 802. Fluid flow is forced from the leading channel end between non-divergent walls to a trailing channel end. The trailing channel end blocks fluid flow. This structure forces the fluid flow to exit feature 826 over the trailing channel end. Further, this creates localized isolated positive pressure near cup-shaped feature 826 and prevents airflow from bleeding into sub-ambient pressure cavity 822.

FIGS. 8-2 illustrates a pressure contour for slider 800. In contrast to the pressure contour illustrated in FIGS. 7-2, isolated pressure pockets exist around side rails 816 and 818 and center pad 820. These pressure pockets help to disperse pressure, especially as slider 800 passes over a disc perturbation. As a result, fly height modulation is reduced.

FIGS. 9-1 illustrates an exemplary slider 900 for use in disc drive 100 as slider 110 in accordance with an embodiment of the present invention. Slider 900 includes slider body 901 having leading slider edge 902 and trailing slider edge 904. In addition, slider body 901 includes first and second side edges 906 and 908, respectively. Slider body 901 also has an air bearing surface 913 configured to face a disc surface. Cavity dam 914 is disposed along leading slider edge 902 and extends substantially between side edges 906 and 908.

Raised rails 916 and 918 extend rearward from cavity dam 914 and are positioned along side edges 906 and 908, respectively. A raised center pad 920 is positioned near trailing edge 904 and includes a raised step surface 923. Collectively, cavity dam 914, rails 916, 918 and pad 920 (along with step surface 923) form a raised portion 921 positioned on the air bearing surface 913. Raised portion 921 is raised above slider body 901 in the range of about 0.6 to 5 microns. Although the raised portion is illustrated as a cavity dam, rails and a pad, those skilled in the art will recognize that any raised portion can be used in accordance with the present invention. Such raised portions include bulges, bumps, projections or other elements raised above the slider body 901. Sub-ambient pressure cavity 922 extends rearward of cavity dam 914 and between rails 916 and 918.

A plurality of cup-shaped features 924 extends substantially from leading slider edge 902 to trailing slider edge 904. In the illustrated embodiment, the plurality of cup-shaped features 924 extend above raised portion 921 in the range of about 0.01 to 0.5 microns. In addition, the plurality of features 924 include recesses similar to those described with regard to slider 800, which are recessed below raised portion 921 in the range of about 0.05 to 1.5 microns. Each of the plurality of cup-shaped features 924 have an opening facing leading slider edge 902 and are positioned on raised portion 921. As illustrated, the plurality of cup-shaped features 924 are arranged in rows from leading slider edge 902 to trailing slider edge 904 and can be positioned on rails 916, 918 and pad 920.

By way of example, feature 926 is one of the plurality of features 924. Feature 926 includes a recess 927 and a raised protrusion 928 trailing and adjacent to the recess 927. This arrangement can improve the damping characteristics of slider 900. In one embodiment, recess 927 is applied using an ion milling or etching process and raised protrusion 928 is applied using a depositing method with diamond-like-carbon (DLC), for example. Other features on the slider 900 or other sliders herein described can be applied using these or other techniques.

Recess 927 is substantially symmetrical and is a recessed convergent channel similar to channel 401 described in relation to FIG. 4. The recessed convergent channel can be of any depth or shape, as desired. As illustrated, recess 927 is adapted to converge pressure to an end for isolation. A leading channel end of recess 927 is open to fluid flow from leading slider edge 902. Fluid flow is forced from the leading channel end between non-divergent walls to a trailing channel end and raised protrusion 928. The trailing channel end and raised protrusion 928 block fluid flow. The structure forces the fluid flow to exit recess 927 over raised protrusion 928. Further, this creates localized isolated positive pressure near cup-shaped feature 926 and prevents airflow from bleeding into sub-ambient pressure cavity 922.

FIGS. 9-2 illustrates a pressure contour for slider 900. Similar to the pressure contour of FIGS. 8-2, isolated pressure pockets exist around side rails 916 and 918 as well as center pad 920. The pockets disperse pressure on the air bearing, which reduce fly height modulation. As demonstrated below, the raised portions (such as raised protrusion 928) of the plurality of features 924 further contribute to damping of slider 900.

Sliders 700, 800 and 900 were tested via a numerical simulation using a Computer Mechanics Laboratory Solver from the University of California-Berkley corresponding to a modal analysis. The analysis measures fluid dynamic oscillation between a slider and a disc, as is known in the art. The results of the numerical simulation are summarized in Table 1. For purposes of Table 1, TE refers to the trailing edge of the slider and LE refers to the leading edge of the slider.

TABLE 1

| | Slider 700 | Slider 800 | Slider 900 |
|---|---|---|---|
| Resonant Frequencies: | | | |
| TE Pitch Mode [kHz] | 87.7 | 84.0 | 82.5 |
| Roll Mode [kHz] | 129.4 | 110.8 | 102.7 |
| LE Pitch Mode [kHz] | 218.9 | 209.6 | 197.8 |
| Damping: | | | |
| TE Pitch Mode [%] | 2.7 | 6.7 | 6.8 |
| Roll Mode [%] | 1.4 | 8.2 | 10.8 |
| LE Pitch Mode [%] | 1.7 | 3.7 | 4.2 |

From Table 1, it is evident that addition of recessed features on slider 800 increases the damping over slider 700. It is further evident that by incorporating both recessed and raised features, as in slider 900, the damping of the system can be further increased. This indicates that patterned DLC features can be used to enhance the damping beyond that which is possible with the recessed features alone. For instance, the roll mode damping of slider 900 was increased by a factor of 7.7 over control slider 700. In addition, pitch mode damping of slider 900 was increased by a factor of 2.5 over slider 700.

Those skilled in the art will recognize that the positioning of the plurality of cup-shaped features can be adjusted to improve damping characteristics. In addition, the feature density (area of feature per surface area) may be adjusted to tailor the amount of damping that is desired. In one embodiment, the feature density is about 50% of a unit area. Effective damping can result from feature densities from 5-85% of a unit area. Further, pressure length scales may be used to determine feature size. For example, an air bearing with a pressure length scale of around 1 micron may use a feature size of around 1 micron or greater.

In summary, one embodiment of the present invention includes a head slider (110, 300, 800, 900) having a slider body (301, 801, 901). The slider body (301, 801, 901) has leading and trailing slider edges (302, 304; 802, 804; 902, 904) and first and second side edges (306, 308; 806, 808; 906, 908), the body (301, 801, 901) including an air-bearing surface (313, 813, 913) configured to face a disc surface. A raised portion (321, 821, 921) is positioned on the air-bearing surface (313, 813, 913). Furthermore, a plurality of isolated cup-shaped features (324, 824, 924) having openings facing the leading slider edge (302, 802, 902) are positioned on the raised portion (321, 821, 921) and extend substantially from the leading slider edge (302, 802, 902) to the trailing slider edge (304, 804, 904).

A further embodiment of the present invention is a method for controlling fly height of a slider (110, 300, 800, 900) over a disc surface having PAMR. The method includes providing a slider (110, 300, 800, 900) with a slider body (301, 801, 901) having leading and trailing slider edges (302, 304; 802, 804; 902, 904) and first and second side edges (306, 308; 806, 808; 906, 908). The slider body (301, 801, 901) further includes an air bearing surface (313, 813, 913) configured to face the disc surface. The method also includes positioning a raised portion (321, 821, 921) on the air-bearing surface (313, 813, 913). Also, a plurality of isolated cup-shaped features (324, 824, 924) are provided on the raised portion (321, 821, 921) and extends substantially from the leading slider edge (302, 802, 902) to the trailing slider edge (304, 804, 904). The plurality of cup-shaped features (324, 824, 924) has openings facing the leading slider edge (302, 802, 902).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the head slider while maintaining substantially the same functionality without departing from the scope and spirit of the present invention. In addition, although the preferred embodiment described herein is directed to a head slider for a disc drive, it will be appreciated by those skilled in the art that the teachings of the present invention can be applied to magnetic, optical or other disc drives, without departing from the scope and spirit of the present invention.

What is claimed is:

1. A head slider for a disc drive comprising:
a slider body comprising leading and trailing slider edges and first and second side edges, the body including an air bearing surface configured to face a disc surface;
a raised portion positioned on the air bearing surface; and
a plurality of isolated cup-shaped features having openings facing the leading slider edge, positioned on the raised portion and extending substantially from the leading slider edge to the trailing slider edge.

2. The head slider of claim 1 wherein the plurality of cup-shaped features include a plurality of cup-shaped protrusions and are arranged in a plurality of columns and rows, wherein the plurality of columns are substantially parallel to the leading slider edge and wherein the plurality of cup-shaped protrusions are positioned along each column, wherein for each column, at least one of the cup-shaped protrusions in the column is offset a distance about the column with respect to at least one other cup-shaped protrusion.

3. The head slider of claim 2 wherein the plurality of cup-shaped protrusions are positioned along each row, wherein for each row, the cup-shaped protrusions are substantially aligned along the row.

4. The head slider of claim 1 wherein the plurality of cup-shaped features have recessed convergent channels, wherein each channel comprises a leading channel end open to fluid flow from the leading slider edge, non-divergent channel side walls, and a trailing channel end closed to the fluid flow from the leading slider edge.

5. The head slider of claim 4 wherein each channel has a depth of about 0.05 to 0.5 microns.

6. The head slider of claim 1 wherein the raised portion comprises first and second raised rails positioned generally along first and second side edges.

7. The head slider of claim 6 wherein the raised portion further comprises a raised center rail extending substantially along the length of the slider body.

8. The head slider of claim 6 wherein the first and second raised rails have a width and wherein the plurality of features extend substantially along the width of the first raised rail and the second raised rail.

9. The head slider of claim 1 wherein the plurality of cup-shaped features extend above the raised portion to a height of approximately 0.1 to 0.5 microns.

10. The head slider of claim 1 wherein the plurality of cup-shaped features include recesses recessed from the raised portion.

11. The head slider of claim 10 wherein the plurality of cup-shaped features are recessed from the raised portion in the range of about 0.05 to 0.5 micron.

12. The head slider of claim 10 wherein the plurality of cup-shaped features include raised protrusions positioned adjacent the recessed portions.

13. The head slider of claim 1 wherein the plurality of cup-shaped features are a shape of at least one of a rectangle, a triangle and a concave surface.

14. A disc drive storage system including the head slider of claim 1 positioned adjacent a disc surface including a pattern assisted magnetic recording.

15. A method for controllers fly height of a slider over a disc surface having PAMR comprising:
providing the slider with a slider body comprising leading and trailing slider edges and first and second side edges, the body including an air bearing surface configured to face the disc surface;
providing a raised portion on the air bearing surface; and
providing a plurality of isolated cup-shaped features on the raised portion extending substantially from the leading slider edge to the trailing sliding edge, wherein the cup-shaped features have openings facing the leading slider edge.

16. The method of claim 15 and further comprising:
arranging the plurality of cup-shaped features in a plurality of columns and rows, wherein the plurality of columns are substantially parallel to the leading slider edge and wherein the plurality of cup-shaped features are positioned along each column, wherein for each column, at least one of the cup-shaped features in the column is offset a distance about the column with respect to at least one other cup-shaped feature.

17. The method of claim 16 wherein the step of arranging further comprises positioning the plurality of cup-shaped features along each row, wherein for each row, the cup-shaped features are substantially aligned along the row.

18. The method of claim 15 and further comprising:
diverting fluid flow from the leading slider edge into recessed convergent channels of the plurality of cup-shaped features; and
blocking the fluid flow from the leading slider edge at a trailing channel end of the plurality of cup-shaped features.

19. The method of claim 18 and further comprising:
isolating fluid flow from the leading slider edge about the plurality of cup-shaped features.

20. The method of claim 15 wherein the step of carrying further comprises orientating the slider at a pitch angle of less than 50 microrads.

21. The method of claim 15 and further comprising:
distributing pressure uniformly from the leading slider edge to the trailing slider edge.

22. The method of claim 15 wherein the plurality of cup-shaped features are provided using an etching process.

23. The method of claim 15 wherein providing the plurality of cup-shaped features comprises recessing the plurality of cup-shaped features from the raised portion.

24. The method of claim 15 wherein providing the plurality of cup-shaped features comprises positioning the plurality of cup-shaped features above the raised portion.

25. A disc drive comprising:
a disc rotatable about an axis and having a disc surface, wherein the disc surface is a pattern assisted magnetic recording;
slider means for supporting a transducer at a fly height above the disc surface during rotation of the disc and reducing modulation of the fly height.
